(19) United States
(12) Patent Application Publication
(10) Pub. No.: US 2024/0251783 A1
(43) Pub. Date: Aug. 1, 2024

(54) COMPOSITIONS AND METHODS FOR LUNG PRESERVATION

(71) Applicant: University Health Network, Toronto (CA)

(72) Inventors: Mingyao Liu, North York (CA); Shafique Keshavjee, Toronto (CA); Marcelo Cypel, Toronto (CA)

(21) Appl. No.: 18/565,387

(22) PCT Filed: Mar. 8, 2022
(86) PCT No.: PCT/CA2022/050334

§ 371 Date: Nov. 29, 2023

Related U.S. Application Data
(60) Provisional application No. 63/195,099, filed on May 31, 2021.

(51) Int. Cl. A01N 1/02

(52) U.S. Cl. CPC A01N 1/0226; A01N 1/0284

(57) ABSTRACT

Provided is a lung preservation composition comprising a non-carbonic buffered nutrient media, preferably a phosphate buffered nutrient media, and a dextran, optionally Dextran 40 and and optionally prostaglandin E1 (PGE1), and optionally at least one of alpha 1 antitrypsin (A1AT), an impermeant, optionally raffinose, an antioxidant, optionally glutathione, and necrostatin-1. Also described is a method of preserving a lung prior to and/or during transplant using said lung preservation composition, and kits comprising one or more components of the lung preservation composition.

### RELATED APPLICATIONS

This Patent Cooperation Treaty application claims the benefit of priority of U.S. Provisional Application 63/195,099 filed May 31, 2021, which is incorporated herein by reference in its entirety.

### FIELD

The present disclosure relates to compositions and methods for lung preservation, specifically to lung preservation compositions and methods for preserving a lung during harvest and/or prior to transplant using such a solution.

### BACKGROUND

The first successful human lung transplantation (LTx) was performed in 1983 (24). Since then, LTx has been conducted worldwide for patients with end-stage lung disease. However, the clinical outcome of LTx still needs to be improved. Many researches have been focused on donor lung preservation, assessments and treatment, in order to improve the quality and quantity of donor lungs for clinical application. Currently, donor lungs can be preserved for 6-8 h at cold temperature. To extend the preservation time period, developing new organ preservation solutions has been an important research subject over the past decades.

Since 1960s, several preservation solutions have been invented. Collins solution was created in 1969 (4). The University of Wisconsin solutions was introduced in 1986 (25). These solutions have high potassium and low sodium to simulate intracellular electrolytes. A low-potassium dextran glucose (LPDG) solution was developed in 1989 (15), and ET-Kyoto solution was developed in 2004 (23). These solutions contain relatively low potassium and high sodium to simulate extracellular electrolytes. Inorganic salts and buffers are major components of these solutions for static cold storage (SCS) of donor organs, to maintain the metabolism at the minimum (13). To improve the function of these solutions, extensive research has been conducted by adding special components or therapeutics. For example, adding raffinose (a trisaccharide) into LPDG solution improved the donor lung preservation (7, 8). Similarly, prostaglandin E1 (PGE1), when added to the LPDG solution, protected lung transplants from ischemia-reperfusion (IR) injury (6).

Previous and recent studies demonstrated that lung preservation at 10° C. is superior to that at 4° C. (5, 26), suggesting relatively higher metabolic rate at 10° C. could be beneficial.

Organ preservation solution studies have been mainly conducted using animal models. It took many animals to test a single experimental condition. It is less likely to test multiple variants with different combinations and multiple time points with animal/organ studies.

Preservation solutions for keeping donor organs in good quality and/or to prevent the development of ischemia reperfusion (IR) injury are desirable.

### SUMMARY

Provided herein in are various aspects of the invention.

As demonstrated herein, the inventors have found that cellular metabolism at low temperature induces cell damage, which can be corrected by adding nutrients and cytoprotective agents to preservation solutions, to improve quality of donor lungs. As described herein, the inventors first used cell culture systems to test multiple conditions, to develop new preservation solutions, and further tested selected solutions with a rat lung preservation model.

The inventors developed a cell culture model to test the effects of hypothermic preservation and warm reperfusion conditions on human lung epithelial cell viability, metabolism, cellular and molecular mechanisms (2, 16, 17). Acute inflammatory response, apoptosis and necroptosis were noted after simulated ischemia-reperfusion conditions (16, 17). Agents, such as alpha 1 antitrypsin (A1AT) (9), protein kinase C delta inhibitors (17, 19), and inhibitors for necroptosis (16) reduced the rate of cell death in IR-model conditions. Therapeutic benefits of these interventions have been shown in rat and pig lung transplants (9, 12, 14, 19), pig lungs during ex vivo lung perfusion (EVLP) (21), and human lungs during EVLP (22). Similar models have been used to study human endothelial cells in the lung transplant setting (3). These model systems provide a unique opportunity to determine the component of organ preservation solutions.

The inventors have demonstrated that the cell culture model allows testing multiple factors for lung preservation and possible mechanisms. The model has been used to show that nutrient-rich formulas may improve organ preservation for example by mitigating the damaging effects of low temperature cellular responses. Preservation compositions that show improved preservation that ware described herein.

Accordingly, an aspect of the invention includes a lung preservation composition comprising a non-carbonic buffered nutrient media, the non-carbonic buffered nutrient media comprising at least one amino acid and at least one vitamin; and a dextran and optionally prostaglandin E1 (PGE1).

Another aspect of the invention comprises a method of cooling and/or preserving a lung prior to transplant, the method comprising: obtaining a lung from a donor subject and flushing the lung with the lung preservation composition described herein and/or storing the lung with the lung preservation composition described herein.

Another aspect of the invention includes use of the lung preservation composition described herein for preserving a lung.

Another aspect of the invention includes a kit comprising at least one nutrient media and at least one vitamin and at least one amino acid, a dextran and optionally prostaglandin E1 (PGE1), wherein the kit is for example for a use described herein.

### BRIEF DESCRIPTION OF THE DRAWINGS

An embodiment of the present disclosure will now be described in relation to the drawings in which:

FIG. 1 Bicarbonate buffer system is not suitable in lung preservation solutions. A. A cell culture model that simulates the hypothermic preservation of donor lung and warm reperfusion. B. The solutions with a bicarbonate buffering system (Steen solution, DMEM, and DMEM plus 10% FBS) had absorbance readings of less than 0.05 (using MTS assay OD readings) after 18 h cold ischemic time (CIT) followed by 4 h warm reperfusion. By contrast, Perfadex™ solution, PBS and 0.9% NaCl had absorbance readings close to 0.3 or higher, suggesting better cell viability in non-bicarbonate buffered solutions under these conditions. C. Adding 5% CO₂ during cell preservation significantly increased the number of lung epithelial cells surviving after 18 h CIT and 4 h reperfusion when cultured in DMEM but had little effect on cells cultured in Perfadex. D. Quantitative cell viability analysis (as measured by absorbance using MTS assays) showed that adding 5% CO₂ had no effect on cell viability when using Perfadex or PBS solution. However, cell viability was significant reduced when 5% CO₂ was added to 0.9% NaCl culture conditions, but significantly increased when 5% CO₂ was added to Steen solution, DMEM, and DMEM plus 10% FBS culture conditions. In each experiment, samples were collected in triplicates. Every experiment was repeated more than 3 times. Statistical significance was *p<0.05 and ***p<0.001, as indicated.

FIG. 2 Phosphate buffered cell culture media improved cell survival after cold preservation and warm reperfusion. As evidenced by absorbance readings in MTS assays, M199(p) showed comparable cyto-protection with that of Perfadex, and RPMI-1640(p), suggesting significantly improved cell viability. A. Human lung epithelial (BEAS-2B) cells. B. Human pulmonary micro vascular endothelial cells. In each experiment, samples were collected in triplicate. Every experiment was repeated more than 3 times. Statistical significance was *p<0.05 and ***p<0.001, as indicated.

FIG. 3 Adding dextran 40 to phosphate buffered cell culture media as potential lung preservation solutions. Extended cold ischemic time (CIT) to 42 h was used to induce more severe cell damage, followed by 4 h reperfusion. A. Dextran 40 increased cell viability when using M199(p). RPMI-1640(p) showed superior cytoprotective effects than M199(p), which was not further enhanced by dextran 40. B. RPMI-1640(p) plus dextran 40 is defined as RPMI-D(p), showed protected cellular morphology after 42 h CIT and 4 h reperfusion. C and D. Similar results were obtained from human pulmonary microvascular endothelial cells. In each experiment, samples were collected in triplicate. Experiments were repeated more than 3 times. Statistical significance was *p<0.05, **p<0.01, ***p<0.001, as indicated.

FIG. 4 Preservation solutions of the disclosure prevented alveolar wall swelling and apoptosis. Rat lungs were flushed with designated cold preservation solutions: 1) Perfadex (Perfadex+PGE1), 2) Perfadex-ARG (Perfadex+PGE1 with A1AT, raffinose and glutathione), 3) RPMI-D(p) (RPMI-1640(p)+PGE1+dextran 40) and stored at 4° C. for 24 h. The rat lungs in the Sham group were flushed with Perfadex without cold storage. A. Representative H&E micrographs of rat lungs. Alveolar wall thickening is noted in the Perfadex group, in comparison with other groups. B. Morphometric measurements show that the alveolar septum thickness is significantly higher in the Perfadex group, which was significantly reduced in Perfadex-ARG and RPMI-D(p) groups (n=75 measures/group). C. Representative TUNEL staining images of rat lungs. D. TUNEL-positive cells are significantly higher in the Perfadex group in comparison with the Sham group, which is significantly lower in Perfadex-ARG and RPMI-D(p) groups (n=60 fields/group). Statistical significance was *p<0.05, **p<0.01, comparing with Sham group; #p<0.05, ##p<0.01, comparing with Perfadex group; $ p<0.05, $$ p<0.01, comparing with Perfadex-ARG group.

FIG. 5 Preservation solutions of the disclosure prevented increased CD31 expression on pulmonary microvascular endothelial cells. After 24 h CIT, lung tissue sections were stained with anti-CD31 and counter stained with DAPI for nuclei. Compared with Sham group, anti-CD31 staining was increased in the Perfadex group, which was not apparent in the other two groups.

FIG. 6 Preservation solutions of the disclosure prevented ultrastructural changes of alveolar wall. After 24 h CIT, the ultrastructure of alveolar wall was examined with transmission electronic microscopy. A. Type II cells. Nuclei (Nu) and lamellar body (Lb) structures can be clearly observed. However, in the Perfadex group, the cytoplasmic portions showed flatten areas (*). B. Alveolar wall structures were preserved in all groups. However, in the Perfadex group, the cytoplasm portions in many cells, again, showed flatten areas (*), which could be the signs of cellular swelling.

### DETAILED DESCRIPTION

Unless otherwise defined, scientific and technical terms used in connection with the present disclosure shall have the meanings that are commonly understood by those of ordinary skill in the art. Further, unless otherwise required by context, singular terms shall include pluralities and plural terms shall include the singular. For example, the term “a cell” includes a single cell as well as a plurality or population of cells. Generally, nomenclatures utilized in connection with, and techniques of, cell and tissue culture, molecular biology, and protein and oligonucleotide or polynucleotide chemistry and hybridization described herein are those well-known and commonly used in the art (see, e.g., Green and Sambrook, 2012).

As used in this specification and the appended claims, the singular forms “a”, “an” and “the” include plural references unless the content clearly dictates otherwise. Thus, for example, a composition containing “a compound” includes a mixture of two or more compounds. It should also be noted that the term “or” is generally employed in its sense including “and/or” unless the content clearly dictates otherwise.

As used in this application and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The terms “about”, “substantially” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “composition” as used herein, a mixture comprising two or more compounds. The composition can comprise two or more distinct compounds and/or two or more “forms” of the compounds, such as, salts, solvates, or, where applicable, stereoisomers of the compound in any ratio. A person of skill in the art would understand that a compound in a composition can also exist as a mixture of forms. For example, a compound may exist as a hydrate of a salt. All forms of the compounds disclosed herein are within the scope of the present disclosure.

The term “dextran” as used herein includes low molecular weight dextran, with average molecular weights less than 100 kDa, or less than 70 kDa, for example having an average molecular weight of 3 kDa to 70 kDa or 20 kDa to 70 kDa. Examples of dextran include Dextran 40 or Dextran 70.

The term “non-carbonic buffered nutrient media” as used herein includes nutrient media wherein the pH is buffered with a buffer not based on bicarbonate, for example where the nutrient media comprises a phosphate, Tris (Hydroxymethyl) Aminomethane (THAM or Tris), histidine, and/or zwitterionic sulfonic acid, optionally HEPES buffer (e.g., buffering system). The non-carbonic buffered nutrient media can comprise low levels of bicarbonate, for example magnesium bicarbonate or calcium bicarbonate, but not for buffering purpose or as a major component thereof. The nutrient media comprise a buffer in an amount sufficient to maintain the average pH of the organ preservation during the period of organ preservation at about the physiologic pH value, for example around 7.2 to 7.4. The non-carbonic buffered nutrient media is an aqueous solution that can support cell survival and/or minimal metabolism of mammalian cells for at least a period of time under static cold storage conditions, for example for at least 8 hours at 4° C. or 10° C. The nutrient media minimally comprises at least one amino acid and at least one vitamin and is compatible with cells and can comprise any of the amino acids, vitamins, PGE1, A1AT, additives etc. described herein.

The term “impermeant” includes compounds that are less permeable to cellular membrane, thus can protect cells from swelling and damage. Examples of such include raffinose, lactobionate, mannitol, glucose, gluconate, sucrose, and/or trehalose.

The term “antioxidant” includes compounds that inhibit oxidation, a chemical reaction that can produce free radicals and damage the cells. Examples of such include glutathione, vitamin C, allopurinol, alpha-ketoglutarate, N-acetyl-cysteine (NAC), magnesium ascorbyl phposphate, lazaroids, and/or vitamin E.

As used herein, the term “preserving” and related terms refers to maintaining the original physiological state and functionality of an organ upon removal from a donor for transplant.

The definitions and embodiments described in particular sections are intended to be applicable to other embodiments herein described for which they are suitable as would be understood by a person skilled in the art.

The recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about”.

Further, the definitions and embodiments described in particular sections are intended to be applicable to other embodiments herein described for which they are suitable as would be understood by a person skilled in the art. For example, in the following passages, different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

An aspect of the invention includes a lung preservation composition comprising a non-carbonic buffered nutrient media, the non-carbonic buffered nutrient media comprising at least one amino acid and at least one vitamin; and a dextran and optionally prostaglandin E1 (PGE1).

In some embodiments, the composition comprises PGE1.

In some embodiments, the composition further comprises at least one of alpha 1 antitrypsin (A1AT), necrostatin-1, one or more impermeant, and/or one or more antioxidant.

In some embodiments, the impermeant is or comprises raffinose.

In some embodiments, the impermeant is or comprises lactobionate.

In some embodiments, the impermeant is or comprises mannitol.

In some embodiments, the impermeant is or comprises glucose.

In some embodiments, the impermeant is or comprises gluconate.

In some embodiments, the impermeant is or comprises sucrose.

In some embodiments, the impermeant is or comprises trehalose.

In some embodiments, the antioxidant is or comprises vitamin C.

In some embodiments, the antioxidant is or comprises allopurinol.

In some embodiments, the antioxidant is or comprises alpha-ketoglutarate.

In some embodiments, the antioxidant is or comprises N-acetyl-cysteine (NAC).

In an embodiment, the composition comprising pentafraction, for example in addition to or as a substitute for dextrin.

In some embodiments, the antioxidant is or comprises magnesium ascorbyl phosphates.

In some embodiments, the antioxidant is or comprises a lazaroid.

In some embodiments, the antioxidant is or comprises vitamin E.

In some embodiments, the dextran is or comprises Dextran 40.

Although serum can be used with nutrient media for cell culture, the preservation compositions described herein lack serum such as fetal bovine serum.

In some embodiments, the non-carbonic buffered nutrient media comprises phosphate, THAM, histidine, and/or zwitterionic sulfonic acid, optionally HEPES, buffer(s).

In some embodiments, the non-carbonic buffered nutrient media is a phosphate buffered nutrient media or comprises a phosphate buffer.

In some embodiments, the non-carbonic buffered nutrient media is a THAM buffered nutrient media or comprises a THAM buffer.

In some embodiments, the non-carbonic buffered nutrient media is a histidine buffered nutrient media or comprises a histidine buffer.

In some embodiments, the non-carbonic buffered nutrient media may comprise a combination of buffers.

In some embodiments, the non-carbonic buffered nutrient media is zwitterionic sulfonic acid, optionally HEPES, buffered nutrient media or comprises a zwitterionic sulfonic acid, optionally HEPES, buffer.

In another embodiment, the non-carbonic buffered nutrient media comprises any cell culture media that lacks a bicarbonate buffer.

In some embodiments, the necrostatin-1 is present in a final concentration of about 5 mg/L to about 15 mg/L.

The preservations solutions described herein comprise for example dextran, optionally Dextran 40.

In some embodiments, the concentration of the Dextran 40 is from about 40 mg/mL to about 60 mg/mL, for example at about 50 mg/mL.

In some embodiments, the glucose is present in a concentration of about 6 mmol/L to about 15 mmol/L. In some embodiments, the glucose is present in a concentration of at least 6 mmol/L, at least 7 mmol/L, at least 8 mmol/L, at least 9 mmol/L, at least 10 mmol/L, for example 11 mmol/L or 12 mmol/L. In some embodiments, the glucose is present in a concentration of about 11 mmol/L.

In some embodiments, the concentration of raffinose is about is about 30 mmol/L to about 50 mmol/L, preferably about 35 mmol/L. In some embodiments, the concentration of raffinose is about 35 mmol/L.

In some embodiments the concentration of PGE1 is from about 100 mg/L about 10,000 mg/mL, preferably 500 mg/L. In some embodiments the concentration of PGE1 is about 500 mg/L.

The concentration of the glutathione in the lung preservation composition may be from about 0.05 mg/L to about 2 mg/L. In some embodiments, the concentration of glutathione is about 0.05 mg/L or about 1 mg/L. In some embodiments, the concentration of glutathione is about 1 mg/L.

In some embodiments, the concentration of A1AT is about 0.5 mg/mL to about 5 mg/mL. In some embodiments, the concentration of A1AT is about 1 mg/ml, 2 mg/ml or 5 mg/mL. In some embodiments, the concentration of A1AT is about 1 mg/mL. In some embodiments, the concentration of A1AT is about 2 mg/ml. In some embodiments, the concentration of A1AT is about 5 mg/mL.

In some embodiments, the at least one vitamin and/or amino acid is at least one of the vitamins and/or amino acids described in Table 2, optionally in the concentrations described therein. In some embodiments, the at least one vitamin and/or amino acids are the combination of vitamins and/or amino acids in the M199(p) composition as described in Table 2, optionally in the concentrations described therein. In some embodiments, the at least one vitamin and/or amino acids are the combination of vitamins and/or amino acids in the RPMI-1640(p) composition as described in Table 2, optionally in the concentrations described therein. In one embodiment, the at least one amino acid is glutamine, optionally in a concentration described in Table 2, optionally about 300 mg/L.

In some embodiments, the at least one vitamin is or comprises choline, optionally choline chloride.

In some embodiments, the at least one vitamin is or comprises calcium pantothenate, optionally D-Calcium pantothenate.

In some embodiments, the at least one vitamin is or comprises folic acid.

In some embodiments, the at least one vitamin is or comprises niacinamide.

In some embodiments, the at least one vitamin is or comprises pyridoxine, optionally pyridoxine HCL.

In some embodiments, the at least one vitamin is or comprises riboflavin.

In some embodiments, the at least one vitamin is or comprises thiamine optionally thiamine HCL.

In some embodiments, the at least one vitamin is or comprises inositol, optionally i-inositol.

In some embodiments, the at least one vitamin is or comprises ascorbic acid.

In some embodiments, the at least one vitamin is or comprises biotin.

In some embodiments, the at least one vitamin is or comprises nicotinic acid.

In some embodiments, the at least one vitamin is or comprises para-aminobenzoic acid.

In some embodiments, the at least one vitamin is or comprises vitamin A.

In some embodiments, the at least one vitamin is or comprises vitamin D2.

In some embodiments, the at least one vitamin is or comprises tocopheral, optionally DL-alpha-tocopherol· PO₄·Na.

In some embodiments, the at least one vitamin is or comprises menadione, optionally menadione NaHSO₃·3H₂O.

In some embodiments, the at least one vitamin is or comprises vitamin B12.

In some embodiments, the at least one vitamin is present in a concentration within the ranges provided in Table 3.

The concentration can be any 0.1 increment between the starting and ending concentration of any range, or the concentration of the start of the range or the end of the range for any vitamin described herein.

The at least one amino acid is for example a L-amino acid.

In some embodiments, the at least one amino acid is or comprises Glycine.

In some embodiments, the at least one amino acid is or comprises arginine, e.g., L-Arginine HCl.

In some embodiments, the at least one amino acid is or comprises cystine, e.g., L-Cystine 2HCl.

In some embodiments, the at least one amino acid is or comprises glutamine, e.g., L-Glutamine.

In some embodiments, the at least one amino acid is or comprises histidine, e.g., L-Histidine HCl· H₂O.

In some embodiments, the at least one amino acid is or comprises isoleucine, e.g., L-Isoleucine.

In some embodiments, the at least one amino acid is or comprises leucine, e.g., L-Leucine.

In some embodiments, the at least one amino acid is or comprises lysine, e.g., L-Lysine HCl.

In some embodiments, the at least one amino acid is or comprises methionine, e.g., L-Methionine.

In some embodiments, the at least one amino acid is or comprises phenylalanine, e.g., L-Phenylalanine.

In some embodiments, the at least one amino acid is or comprises serine, e.g., L-Serine.

In some embodiments, the at least one amino acid is or comprises threonine, e.g., L-Threonine.

In some embodiments, the at least one amino acid is or comprises tryptophan, e.g., L-Tryptophan.

In some embodiments, the at least one amino acid is or comprises tyrosine, e.g., L-Tyrosine disodium salt·2H₂O.

In some embodiments, the at least one amino acid is or comprises valine, e.g., L-Valine.

In some embodiments, the at least one amino acid is or comprises alanine, e.g., L-Alanine.

In some embodiments, the at least one amino acid is or comprises aspartic acid, e.g., L-Aspartic acid.

In some embodiments, the at least one amino acid is or comprises cysteine, e.g., L-Cysteine HCl·H₂O.

In some embodiments, the at least one amino acid is or comprises glutamic acid, e.g., L-Glutamic Acid.

In some embodiments, the at least one amino acid is or comprises aspartic acid, e.g., hydroxyproline, optionally L-Hydroxyproline

In some embodiments, the at least one amino acid is or comprises proline, e.g., L-Proline.

In some embodiments, the at least one amino acid is or comprises arginine, e.g., L-Arginine.

In some embodiments, the at least one amino acid is or comprises asparagine, e.g., L-Asparagine.

In some embodiments, the at least amino acid is present in a concentration within the ranges provided in Table 3.

In some embodiments, the at least one amino acid is present in a concentration within the ranges provided in Table 4.

The concentration can be any 0.1 increment between the starting and ending concentration of any range, or the concentration of the start of the range or the end of the range described herein, including for example Table 2, 3 and/or 4.

Where reference is made to a particular compound or concentration herein for example in a Table, it would be understood that suitable variants of compounds, such as different salts, could be substituted. For example, a different salt of a component could be used and for example at a concentration that provides the component such as an ion, at a similar concentration as recited herein. The substitutions/variants contemplated are ones which are compatible with cells such as lung endothelial cells and suitable for mammalian e.g., human use.

Combinations of any of the components mentioned are contemplated, including for example combinations of vitamins, or a vitamin or vitamins and a different component such as an amino acid or multiple different components, for example multiple amino acids, one or more antioxidants, PGE1, A1AT, one or more additives etc. In some embodiments, the composition further comprises one or more additives.

In some embodiments, the one or more additives is or comprises adenine, optionally Adenine sulfate.

In some embodiments, the one or more additives is or comprises 5-Adenylic acid.

In some embodiments, the one or more additives is or comprises ATP.

In some embodiments, the one or more additives is or comprises Cholesterol.

In some embodiments, the one or more additives is or comprises 2-deoxy-D-ribose.

In some embodiments, the one or more additives is or comprises guanine optionally Guanine·HCl.

In some embodiments, the one or more additives is or comprises Hypoxanthine, Na.

In some embodiments, the one or more additives is or comprises D-Ribose.

In some embodiments, the one or more additives is or comprises Sodium acetate.

In some embodiments, the one or more additives is or comprises Thymine.

In some embodiments, the one or more additives is or comprises Tween 80.

In some embodiments, the one or more additives is or comprises Uracil.

In some embodiments, the one or more additives is or comprises Xanthine.

In some embodiments, the one or more additives is present in a concentration within the ranges provided in Table 3. In some embodiments, the at least amino acid is present in a concentration within the ranges provided in Table 4.

In some embodiments, the at least one vitamin is choline, Calcium pantothenate, folic acid, niacinamide, pyridoxine, riboflavin, thiamine, inositol, ascorbic acid, biotin, nicotinic acid, para-aminobenzoic acid, vitamin A, vitamin D2, alpha-tocopherol, and/or menadione.

In some embodiments, the at least one vitamin is choline chloride, D-Calcium pantothenate, folic acid, niacinamide, pyridoxine, riboflavin, thiamine HCL, i-inositol, ascorbic acid, biotin, nicotinic acid, para-aminobenzoic acid, vitamin A, vitamin D2, DL-alpha-tocopherol and/or menadione.

In an embodiment, the concentration of the at least one vitamin is as in the M199(p) composition as provided in Table 2. In some embodiments, the at least one vitamin is present in a concentration within the ranges provided in Table 3. In some embodiments, the at least one vitamin is present in a concentration within the ranges provided in Table 4.

In some embodiments, the at least one amino acid is Glycine, Arginine, Cystine, Glutamine, Histidine, Isoleucine, Leucine, Lysine, Methionine, Phenylalanine, Serine, Threonine, Tryptophan, Tyrosine, Valine, Alanine, Aspartic acid, Cysteine, Glutamic Acid, Hydroxyproline, and/or Proline.

For example, the at least one amino acid can be L-Glycine, L-Arginine HCl, L-Cystine 2HCI, L-Glutamine, L-Histidine HCl·H₂O, L-Isoleucine, L-Leucine, L-Lysine HCl, L-Methionine, L-Phenylalanine, L-Serine, L-Threonine, L-Tryptophan, L-Tyrosine disodium salt·2H₂O, L-Valine, L-Alanine, L-Aspartic acid, L-Cysteine HCl·H₂O, L-Glutamic Acid, L-Hydroxyproline, and/or L-Proline.

In an embodiment, the concentration of the at least one amino acid is as in the M199(p) composition as provided in Table 2. In some embodiments, the at least one amino acid is present in a concentration within the ranges provided in Table 3. In some embodiments, the at least amino acid is present in a concentration within the ranges provided in Table 4.

In some embodiments, the composition further comprises one or more additives selected from Adenine sulfate, 5-Adenylic acid, ATP, Cholesterol, 2-deoxy-D-ribose, Guanine, Hypoxanthine, D-Ribose, Sodium acetate, Thymine, Tween 80, Uracil, and/or Xanthine. In an embodiment, the concentration of the at least one amino acid is as in the M199(p) composition as provided in Table 2. In some embodiments, the at least one additive is present in a concentration within the ranges provided in Table 3.

In some embodiments, the at least one vitamin is choline, pantothenate, folic acid, niacinamide, pyridoxine, riboflavin, thiamine, inositol, biotin, para-aminobenzoic acid, and/or vitamin B12. In an embodiment, the concentration of the at least one vitamin is as in the RPMI-1640(p) composition as provided in Table 2. In some embodiments, the at least one vitamin is present in a concentration within the ranges provided in Table 3. In some embodiments, the at least one vitamin is present in a concentration within the ranges provided in Table 4.

In some embodiments, the at least one amino acid is selected from L-Cystine, L-Glutamine, L-Isoleucine, L-Leucine, L-Lysine, L-Methionine, L-Phenylalanine, L-Serine, L-Threonine, L-Tyrosine, L-Valine, L-Hydroxyproline, L-Proline and/or L-Arginine. In an embodiment, the concentration of the at least one amino acid is as in the RPMI-1640(p) composition as provided in Table 2. In some embodiments, the at least one amino acid is present in a concentration within the ranges provided in Table 3. In some embodiments, the at least one amino acid is present in a concentration within the ranges provided in Table 4.

In some embodiments, the at least one amino acid is at least three essential amino acids, at least 4 essential amino acids, at least 5 essential amino acids, at least 6 essential amino acids, or at least 7 essential amino acids. In some embodiments, the at least one amino acid at least 3 essential amino acids.

Combinations of two or more of the components both from a type of component or different components are contemplated.

Conventional procedures and ingredients for the selection and preparation of suitable compositions are described, for example, in Remington's Pharmaceutical Sciences (2000-20th edition) and in The United States Pharmacopeia: The National Formulary (USP 24 NF19) published in 1999.

In another embodiment, the lung preservation composition further comprises at least one inorganic salt. In some embodiment, the at least one inorganic salt is at least one of the inorganic salts described in Table 1, optionally in the concentrations described therein, or Table 2, optionally in the concentrations described therein. In some embodiments, the at least one inorganic salt are the combination of the inorganic salts in the M199(p) composition as described in Table 2, optionally in the concentrations described therein. In some embodiments, the at least one inorganic salt are the combination of inorganic salts in the RPMI-1640(p) composition as described in Table 2, optionally in the concentrations described therein. In some embodiments, the at least one inorganic salt are the combination of inorganic salts in the Perfadex™ composition as described in Table 1, optionally in the concentrations described therein.

In another embodiment, the phosphate buffered nutrient media comprises one or more of the components of the RPMI-1640(p) composition as described in Table 2, optionally in the concentrations described therein, or one or more of the components of the M199(p) composition as described in Table 2, optionally in the concentrations described therein, or one or more of the components of the Perfadex™ composition as described in Table 1, optionally in the concentrations described therein; and at least one cytoprotective agent.

In another embodiment, the lung preservation composition comprises one or more of the components of the RPMI-1640(p) composition as described in Table 2, optionally in the concentrations described therein, and PGE1, optionally in a concentration of about 0.5 mg/mL, and optionally, a colloid, optionally Dextran 40, optionally in a concentration of about 50 mg/mL.

In another embodiment, the lung preservation composition comprises one or more of the components of the M199(p) composition as described in Table 2, optionally in the concentrations described therein, and a colloid, optionally Dextran 40, optionally in a concentration of about 50 mg/mL.

In another embodiment, the lung preservation composition comprises one or more of the components of the Perfadex™ composition as described in Table 1, optionally in the concentrations described therein. In a further embodiment, the lung preservation composition comprises any one of the base compositions described herein and A1AT, raffinose, PGE1, and glutathione.

In some embodiments, the composition further comprises one or more inorganic salts selected from Na⁺, K⁺, Cl⁻, Mg²⁺ and/or Ca²⁺.

In some embodiments, the composition further comprises Na⁺.

In some embodiments, the composition further comprises K⁺.

In some embodiments, the composition further comprises Cl⁻.

In some embodiments, the composition further comprises Mg²⁺.

In some embodiments, the composition further comprises Ca²⁺.

In some embodiments, the composition comprises one or more inorganic salts. In an embodiment, the concentration of the at least one vitamin is as in the RPMI-1640(p) or M199(p) compositions as provided in Table 2. In some embodiments, the one or more organic salts is present in a concentration within the ranges provided in Table 3.

In some embodiments, the non-carbonic buffered nutrient media is a phosphate and THAM buffered nutrient media comprising Na⁺, K⁺, Cl⁻, Mg²⁺, glucose, dextran 40, and sulphate. In some embodiments, the Na⁺ is present in a concentration of about 138 mM, the K⁺ is present in a concentration of 6 mM, the Cl⁻ is present in a concentration of 142 mM, the Mg²⁺ is present in a concentration of 0.8 mM, the glucose is present in a concentration of 5.5 mM, the dextran 40 is present in a concentration of 50 g/L, the phosphate is present in a concentration of 0.8 mM, and the THAM is present in a concentration of 1 mM.

In some embodiments, the non-carbonic buffered nutrient media has a pH of about 7.2 to about 7.4. In some embodiments, the non-carbonic buffered nutrient media has an osmolarity of about 260 mOsm/L to about 320 mOsm/L. In some embodiments, the non-carbonic buffered nutrient media has an osmolarity of about 290 mOsm/L or 292 mOsm/L.

In some embodiments, the lung preservation composition has an osmolarity of more than 300 mOsm/L. In some embodiments, the lung preservation composition has an osmolarity of less than 360 mOsm/L or less than 350 mOsm/L or less than 340 mOsm/L or less than 330 mOsm/L or less than 320 mOsm/L.

Osmolarity can be determined and/or modified using known methods.

In another embodiment, the lung preservation composition comprises a combination of at least two of the cytoprotective agents described herein.

In another embodiment, the nutrient media has a pH and/or osmolarity as described in Table 2. In another embodiment, the nutrient media has a pH and/or osmolarity as described for Perfadex™ in Table 1. In one embodiment, the lung preservation composition has a pH between about 7.35 and about 7.45.

In some embodiments, the osmolality of the lung preservation composition is about 275-299 milli-osmoles per kilogram.

In some embodiments, the non-carbonic buffered nutrient media is sterile and/or has been sterilized. For example, the nutrient media can be heat sterilized or subjected to sterile filtration.

The compositions can be made based on the concentrations provided herein. For example, sodium phosphate monobasic and dibasic solutions can be mixed in proportions to provide a desired pH, adding the additional components, and adjusting the final volume for example to 1L with deionized water. The pH if necessary, can be adjusted with acid such as hydrogen chloride or a base such as potassium hydroxide (KOH) using a sensitive pH meter.

Another aspect of the invention comprises a method of cooling and/or preserving a lung, prior to transplant comprising: obtaining a lung from a donor subject and flushing the lung with a lung preservation composition described herein and/or storing the lung with a lung preservation composition described herein. The lung may be stored by placing the lung in a container comprising the lung preservation composition. The stored lung may be transported. For example, the container can be a transport container. The compositions may be particularly useful where there is an extended time between procurement and recipient transplant. The compositions may be suitable for other organs. In one embodiment, the organ is a lung, heart, liver, pancreas, or kidney.

In some embodiments, the subject is a human. In some embodiments, the lung is flushed with the lung preservation composition and then stored, optionally at a low temperature, in a preservation composition described herein for up to about 24 h, optionally about 6 h, optionally about 12 h, optionally about 24 h or any amount of time from 5 minutes to 24 hours or any one 1 min increment therebetween. The composition of the preservation solution to flush and store is typically the same but can also be different.

In further embodiments the low temperature is about 4 degrees Celsius or about 10 degrees Celsius. The composition can be at any temperature below 37 degrees Celsius, preferably below 15 degrees Celsius.

In an embodiment, the method of preserving an organ such as a lung, comprises a step of obtaining a volume of the lung preservation composition from a sterile container in which the composition has been stored and adding the obtained volume to the organ, thereby preserving the organ.

The preservation solutions can be used for flushing, storing, and/or transporting a harvested lung after removal from a donor in preparation for eventual transplantation into a recipient.

In an embodiment, the method comprises flushing a lung obtained from a donor with a flushing volume of a lung preservation composition and filling a sterile organ storage container at least partially with a filling volume of the preservation composition and immersing the lung in the storage container.

Another aspect of the invention includes use of the lung preservation composition described herein for cooling and/or preserving ex vivo donor organs, preferably lungs. In some embodiments, the lung is preserved for up to about 24 h. In some embodiments, the lung is a human lung. In some embodiments, the lung is preserved at a temperature of about 4 degrees Celsius or about 10 degrees Celsius. The composition can be at any temperature below 37 degrees Celsius, preferably below 15 degrees Celsius. In further embodiments, the lung is preserved prior to and/or during transplant.

Also provided herein is a non-carbonic nutrient media for use in organ preservation.

In some embodiments, the method or use is for reducing ischemia-reperfusion injury to the organ.

Another aspect of the invention includes a kit comprising at least one nutrient media and at least one vitamin and at least one amino acid. The kit can comprise dextrin and/or PGE1. In some embodiments the kit further comprises at least one of the inorganic salts, vitamins and/or amino acids, optionally glutamine, of Table 2. In other embodiments, the kit comprises the composition described herein and at least one container and/or vial. In some embodiments, one or more of the components are provide premixed or are provided separately, for example in separate containers, to be combined. Any of the components described herein may be comprised in the kit or used in the methods or uses described.

The above disclosure generally describes the present application. A more complete understanding can be obtained by reference to the following specific examples. These examples are described solely for the purpose of illustration and are not intended to limit the scope of the application. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present disclosure:

### EXAMPLES

### Example 1: Methods

### Cell Culture Model to Simulate IR Process of Lung Transplantation

Human lung epithelial (BEAS-2B) cells or human pulmonary microvascular endothelial cells (HPMEC) were cultured to confluence at 37° C., 5% CO₂ in DMEM (Gibco; Waltham MA) with 10% of fetal bovine serum (FBS, Gibco), or in M199 medium (Thermo Scientific, Waltham MA) with 20% of FBS, respectively. After cells reached confluence, medium was replaced with different testing solutions, and cells were switched to a chamber at 4° C. with 50% O₂ to simulate hypothermic lung preservation. After different periods of cold ischemic time (CIT), cells were switched back to DMEM+10% FBS or M199+20% FBS at 37° C. with 5% CO₂ for 4 h to simulate reperfusion. Cell morphology was recorded with phase contrast microscopy.

CellTiter 96® AQueous One Solution Cell Proliferation Assay (MTS) was used to determine effects of different solutions on cell viabilities. Cells were seeded in 96-well plates at 15,000 cells/100 μl/well, and incubated with serum containing culture medium as described above, at 37° C./5% CO₂ overnight. After switching to different preservation solutions for various periods of CIT, and followed by 3 h simulated reperfusion, and then 20 μl of CellTiter 96@ AQueousOne Solution (Promega; Madison, WI) was added to each well. After additional 1 h incubation, optical density of each well was measured using a plate reader (Biotek Instrument Inc., Winooski, VT) set to 490 nm.

### Rat Lung Preservation Test

Lewis rats (10-12 weeks old, male, 276-305 g) were purchased from Charles River (Senneville, Canada). Animal was anesthetized using isoflurane USP (Fresenius Kabi Canada Ltd, Richmond Hill, Canada), and intubated with a 16-gauge angiocatheter (BD Canada, Oakville, Canada) orotracheally. The angiocatheter was connected to a volume-controlled ventilator (Harvard Rodent Ventilator, Model 683, Harvard Apparatus, South Natick, MA), and the animal was ventilated at a rate of 70 breaths/min, a tidal volume of 10 ml/kg, a FiO2 of 1.0, and a positive end-expiratory pressure of 2 cmH₂O. After laparotomy, 100 USP/kg of heparin (LEO Pharma Inc., Thornhill, Canada) was injected into inferior vena cava. Five minutes after heparin injection, a median sternotomy was performed, inferior vena cava was incised, and the right and left auricular appendage and apex of heart were excised. A 14 G angiocatheter was placed on the base of the pulmonary vein through the excised apex of the heart. The lungs were flushed with 20 ml of selected preservation solution from a height of 20 cm above the heart. After flushing, the trachea was tied at an inflated phase of ventilation. The heart-lung block was removed and placed in 20 ml of the preservation solution at 4° C. Following 24 h cold preservation, samples were collected from the heart-lung blocks. For a sham group, lungs were collected just after flushing with Perfadex™ without CIT. This study was approved by the Animal Use Committee at the University Health Network (Toronto, Canada).

### Histologic Assessments

Paraffin-embedded rat lung samples were used for hematoxylin and eosin staining. Micrographs were scanned with Aperio AT2 scanner (Laica, Solm, Germany). The alveolar wall thickness was measured in a blinded manner with Image J software (ImageJ v1.44; US National Institutes of Health, Bethesda, MD).

TUNEL (terminal deoxynucleotidyl transferase UTP nick-end labeling) positive cells were assessed by in situ cell death kit, TMR red (Roche, Basel, Switzerland). Ten fields per slide were photographed with Nikon air microscope (Nikon, Tokyo, Japan). TUNEL positive red cells and blue stained nuclei were counted in a blinded manner using NIS Elements Basic Research Microscope Imaging Software (Nikon). The results were presented as the ratio of TUNEL positive cells to total cells.

Formalin-fixed, paraffin-embedded tissue sections (5 μm) were mounted on positively charged microscope slides. Antigen retrieval was performed with microwave heating in citrate buffer (pH 6.0). Endogenous peroxidase and biotin activities were blocked, respectively, using 3% hydrogen peroxide and avidin/biotin blocking kit (Thermo Scientific). After blocking for 30 min with protein block, CD31 antibody (Abcam, Cambridge, United Kingdom) was applied at 4° C. overnight. Slides were then washed, and Goat anti rabbit Alexa Fluor 488 was added. Slides were then counter stained with DAPI and mounted with mounting medium. Nikon air was used to capture the immunofluorescent images.

### Transmission Electron Microscopy

After a 24 h cold preservation or immediately after flushing (sham group), the right lower lobe of the lung was resected by simple ligation and prepared for ultrastructural examination. Small pieces of the lung tissues were immersed in universal fixative (1% glutaraldehyde, 4% paraformaldehyde, pH 7.40) immediately after biopsy, post fixed in 1% osmium tetroxide, dehydrated in graded acetones, and embedded in an epon-araldite mixture. One-micrometer-thick sections were stained with toluidine blue, and ultrathin sections from randomly chosen blocks were stained. The grids were examined with a Philips 201 electron microscope (N.V. Philips, Gloeilampenfabrieken, Eindhoven, The Netherlands).

### Statistical Analysis

Data were analyzed by SPPS Ver. 20 (IBM, Armonk, NY). Numerical data were compared using one-way ANOVA and the Games-Howell post hoc test. Results are considered statistically significant at p<0.05.

### Example 2: Results

The following experiments were performed using the methods as described in Example 1.

Commonly, donor lungs are preserved with low potassium dextran glucose (LPDG) solution at low temperature. It was hypothesized that adding nutrients and/or cytoprotective agents to preservation solutions improves donor lung quality. Human lung epithelial cells and human pulmonary microvascular endothelial cells cultured at 37° C. with serum containing medium were switched to designated testing solutions at 4° C. with 50% O₂ for different cold ischemic time, followed by switching back to serum containing culture medium at 37° C. to simulate reperfusion. The inventors found that bicarbonate buffer system should be avoided in preservation solution. When pH was maintained at physiological levels, cell culture media showed better cell survival than in low potassium dextran glucose solution. Phosphate buffered cell culture media were further improved by adding colloid dextran 40. When rat donor lungs were preserved at 4° C. for 24 h, RPMI-1640(p) medium plus dextran 40 or adding cytoprotective agents (alpha 1 antitrypsin, raffinose and glutathione) to low potassium dextran glucose solution prevented alveolar wall swelling, apoptosis, activation of endothelial cells and cellular edema. Using nutrient-rich solution and/or adding multiple cytoprotective agents is a new direction for designing and developing organ preservation solutions. Cell culture model, as a screening tool reduces the use of animals and provides potential underlying mechanisms.

### Regular Culture Medium or Steen Solution Severely Damaged Lung Epithelial Cells During CIT

Mesenchymal stem cells-conditioned medium contains multiple growth factors and cytokines. To test its potential therapeutic benefits for IR injury in lung transplant, a cell culture model that simulates the IR process of LTx (2, 17) was used. Cells were preserved at 4° C. with 50% O₂ with conditioned medium and then reperfused with DMEM plus 10% FBS at 37° C. Interestingly, cells treated with either the conditioned medium, or regular culture medium as a control all died after simulated CIT and reperfusion (data not shown). This trigged the inventors to explore why regular cell culture medium cannot be used for cells through static cold storage (SCS) and warm reperfusion.

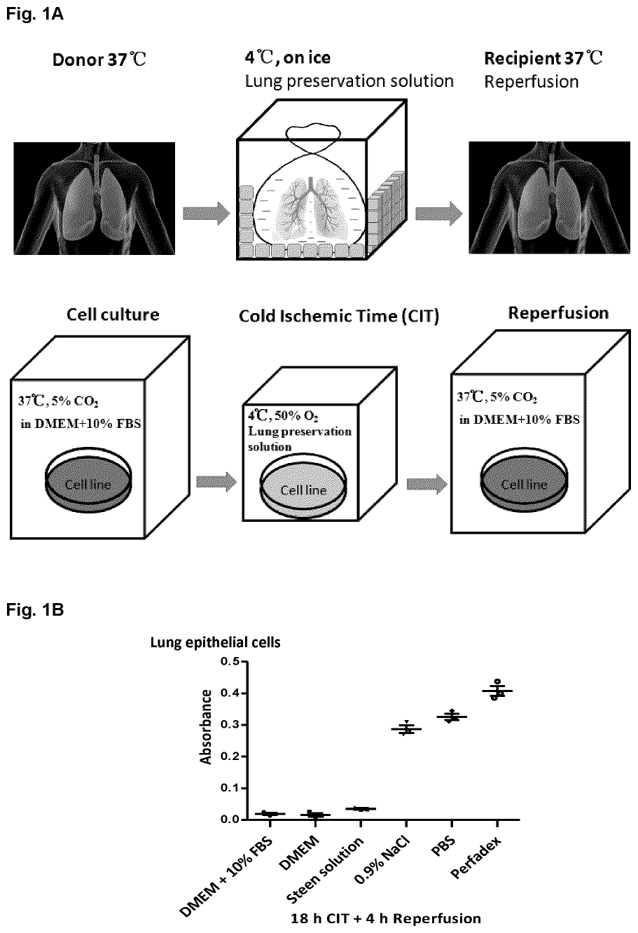

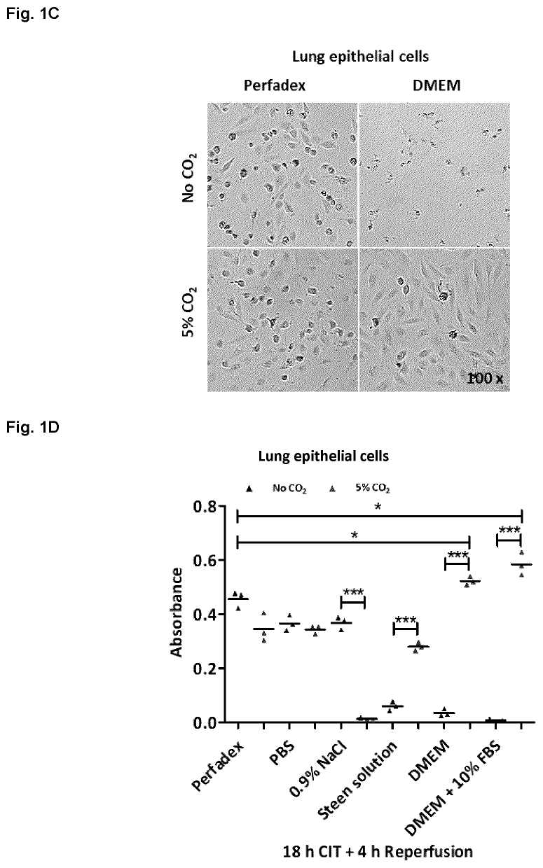

To simulate lung SCS and warm reperfusion, human lung epithelial BEAS-2B cells were first cultured at 37° C., in 5% CO₂ with DMEM plus 10% FBS. Cells were then switched to cold solutions at 4° C. with 50% O₂, followed by simulated reperfusion with DMEM plus 10% FBS at 37° C. in 5% CO₂ (FIG. 1A). Comparison was done using Perfadex™ (a commercially available LPDG solution used clinically for donor lung preservation), phosphate buffer (PBS), 0.9% NaCl, Steen solution (a commercially available perfusate used for EVLP), DMEM, or DMEM plus 10% FBS. After 18 h CIT followed by 4 h reperfusion, cell viability was dramatically reduced in Steen solution, DMEM, or DMEM plus 10% FBS, compared with cells preserved in Perfadex™. Cells in PBS or 0.9% NaCl solution showed better cell viability than in the other 3 solutions (FIG. 1B).

Bicarbonate Buffer should be Avoided from Donor Lung Preservation Solutions

It was observed that one of the main differences among these solutions is the buffer system used. Perfadex™ uses phosphate buffer and small amount of THAM, PBS is a strongly phosphate buffered salt solution, while 0.9% NaCl does not have a buffer. On the other hand, the main buffer system in DMEM, or in Steen solution, is bicarbonate (Table 1). Bicarbonate buffer is required for cells cultured with 5% CO₂, a physiological condition to mimic microenvironment in vivo. EVLP is a technology to maintain donor lung at body temperature with close to physiological ventilation and perfusion, in order to assess lung function and repair donor lung injury (10). Steen solution, the most popularly used EVLP perfusate, also contains bicarbonate buffer. However, during a cold preservation period, the donor lungs are inflated with 50% O₂ and 50% room air. Cell metabolism and respiration are reduced at cold temperature; thus, the generation of CO₂ is limited. In this situation, the lack of CO₂ to counterbalance the bicarbonate could increase the pH, which could lead to cell death. To prove this mechanism, cells preserved at 4° C. for 18 h with 50% O₂, in the presence or absence of 5% CO₂. Adding 5% CO₂ had little effects on cell morphology in Perfadex™ solution, but significantly rescued cells from death in DMEM and cell morphology changes (FIG. 1C). Cell viability assay shows that 5% CO₂ did not affect cells in Perfadex™ or PBS, but significantly reduced alive cells in 0.9% NaCl, indicating the requirement of buffer system in the preservation solution. By contrast, 5% CO₂ improved cell viability for cells preserved in the Steen solution, DMEM, or DMEM plus 10% FBS. Importantly, the viability of cells in DMEM or DMEM plus 10% FBS even significantly better than that in Perfadex™ (FIG. 1D). These results not only supported our speculation on the effects of different types of buffering systems in preservation solution, but also demonstrated that when pH is corrected, solutions with more nutrients are better for cells.

TABLE 1
Components of solutions tested in cell culture model.

| | | | | | |
|---|---|---|---|---|---|
| Constit- | | | 0.9% | | |
| uent | Perfadex ® | PBS | NaCl | STEEN ™ | DMEM |

Salt (mM)

| | | | | | |
|---|---|---|---|---|---|
| Na⁺ | 138 | 161 | 154 | 102 | 156 |
| K⁺ | 6 | 1.1 | | 4.6 | 5.3 |
| Cl⁻ | 142 | 155 | 154 | 96 | 119 |
| Mg²⁺ | 0.8 | | | 1.2 | 0.8 |
| Ca²⁺ | | | | 1.5 | 1.8 |
| Glucose | 5.5 | | | 11 | 5.5 |
| Dextran 40 | 50 g/L | | | 5 g/L | |
| Albumin | | | | 70 g/L | |

Buffer (mM)

| | | | | | |
|---|---|---|---|---|---|
| Phosphate | 0.8 | 4.0 | | 1.2 | 0.9 |
| Bicarbonate | | | | 15 | 44 |
| THAM | 1 | | | | |
| Others | Sulphate | | | | Amino acids |
| | | | | | Vitamins |
| | | | | | Pyruvate |
| | | | | | Phenol Red |
| | | | | | Fe(NO₃)₃ |
| | | | | | Sulphate |
| pH | 7.40 | 7.40 | 7.0 | 7.20 | 7.20 |
| Osmolarity | 292 | 300 ± 20 | 308 | 300 ± 20 | 330 ± 30 |
| (mOsm/L) | | | | | |

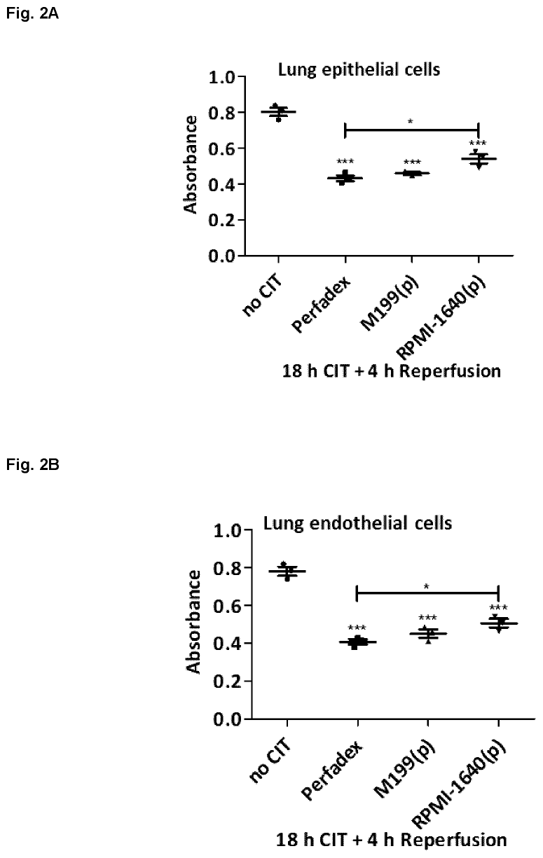

A comparison was done to test whether phosphate-buffered cell culture medium is able to outperform Perfadex™ during CIT. Most commercially available culture media use bicarbonate as the primary buffering system. Interestingly, two phosphate buffered culture media were found: M199(p) and RPMI-1640(p). These two media were compared with Perfadex™ on both human lung epithelial cells and human pulmonary microvascular endothelial cells. Under the 18 h CIT condition, M199(p) showed similar cell viability with Perfadex, and RPMI-1640(p) performed significantly better than Perfadex in both cell types (FIG. 2).

### Develop Phosphate Buffered Culture Media as Preservation Solutions

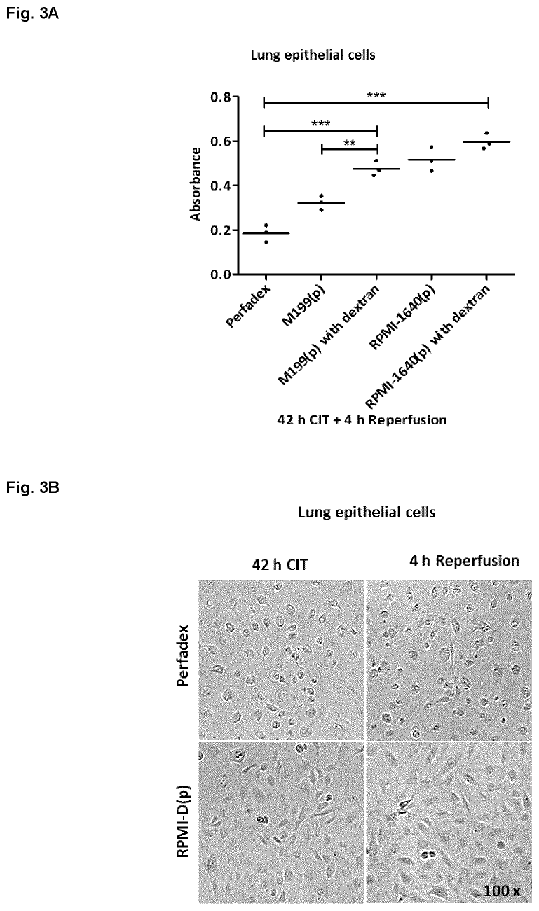

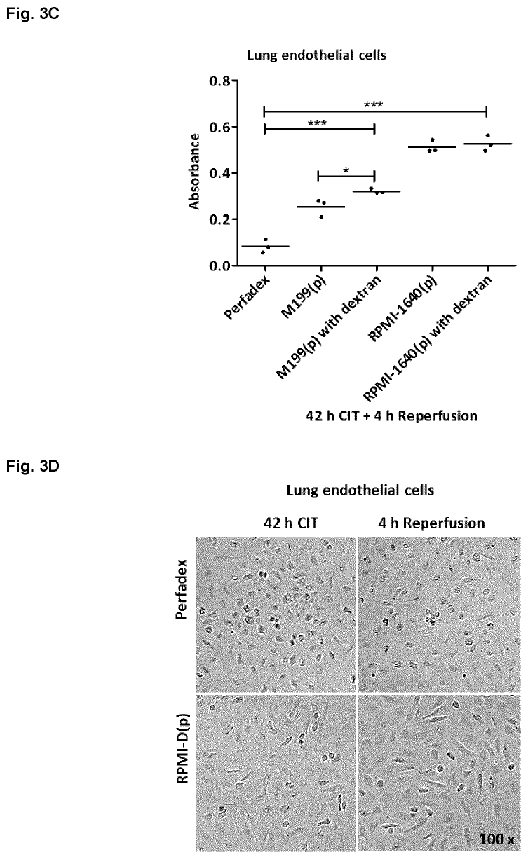

Dextran 40 is the colloid used in Perfadex™ (15) and in the Steen solution (Table 1). To determine the cytoprotective effects of dextran 40 during CIT, dextran 40 at 50 mg/ml was added to M199(p) or RPMI-1640(p), the same concentration as used in Perfadex™. To generate more severe cell injury, CIT was extended from 18 h to 42 h. Under this new condition, both M199(p) and RPMI-1640(p) significantly improved cell viability. Addition of dextran 40 further significantly improved cell viability in M199(p) medium in both lung epithelial and endothelial cells. The cytoprotective effect of RPMI-1640(p) was much superior to that in Perfadex and M199(p), and it was not further enhanced by the dextran 40 (FIG. 3).

Two Formulas Kept Rat Lung Alveolar Wall from Swelling after 24 h CIT

The superior performance of phosphate buffered culture media in preventing cells from the SCS and warm reperfusion induced injury promoted us to test whether these media could be used for donor lung preservation. Three formulas were tested. Since adding PGE1 (0.5 mg/ml) into Perfadex™ solution significantly improved its protective effects in donor lung preservation (6), it was routinely added to Perfadex™ both clinically and experimentally. This condition was used as a control in the present study (Perfadex group). A1AT showed anti-inflammatory and anti-cell death effects both in vitro and in vivo in LTx settings (9, 12, 21, 22). Raffinose showed cytoprotective effects in Perfadex (7, 8), and glutathione, an antioxidant, has been used in organ preservation solutions (such as University Wisconsin, Celsior, and IGL-1 solutions) (13). A1AT (1 mg/ml), raffinose (17.8 mg/ml), and glutathione (1 μg/ml) were added into Perfadex solution, together with PGE1 (0.5 mg/ml) as the second group (Perfadex-ARG). Dextran 40 (50 mg/ml) and PGE1 (0.5 mg/ml) were added into RPMI-1640(p) and referred to as RPMI-D(p), as the third group.

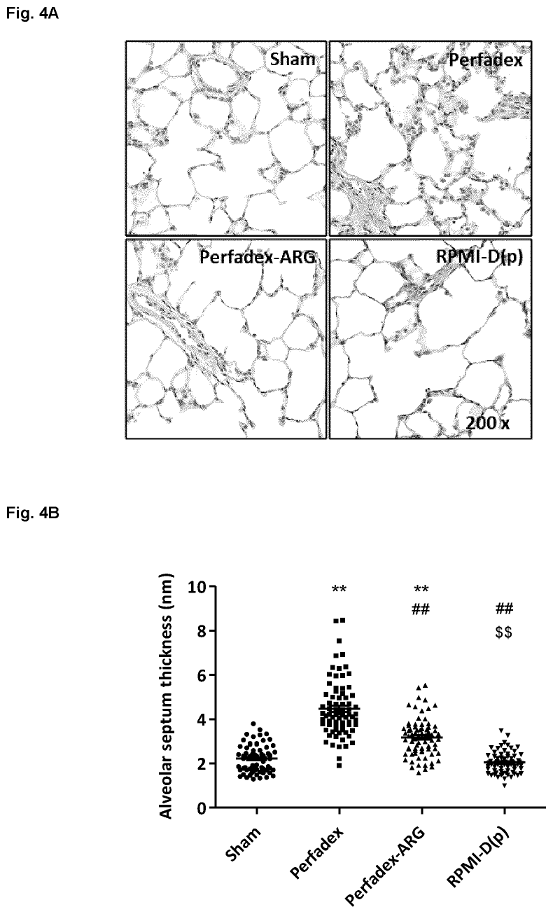

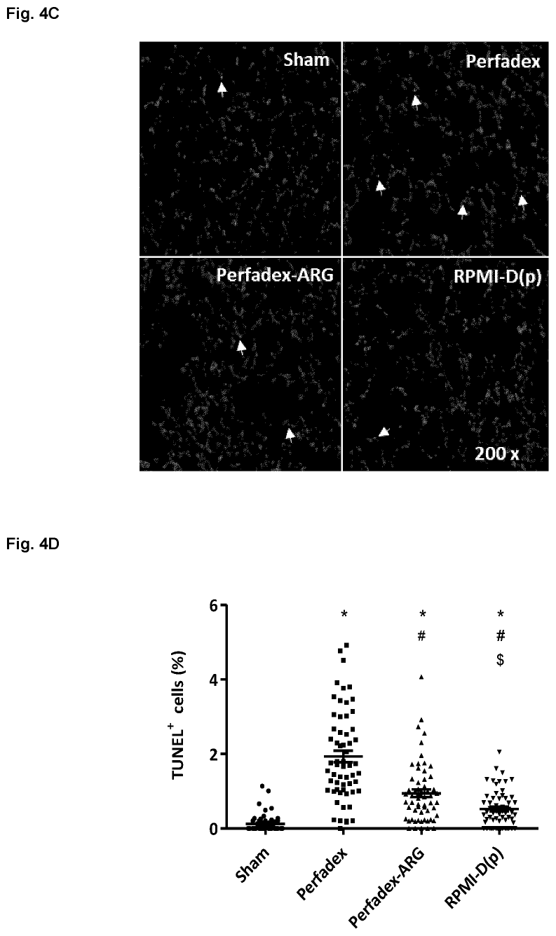

To compare these solutions, rat lungs were flushed with 20 ml of each of the selected solutions, and then preserved at 4° C. for 24 h. The Sham group was flushed as the Perfadex group without hypothermic preservation. The lung sections with H & E staining showed that compared with the Sham group, the thickness of alveolar wall in Perfadex group was significantly increased. Perfadex-ARG and RPMI-D(p) prevented alveolar walls from swelling (FIG. 4A). Quantitative measurement shows the alveolar septum thickness of RPMI-D(p) group was significantly thinner than that of Perfadex and Perfadex-ARG groups, and Perfadex-ARG group was significantly thinner than that of Perfadex group (FIG. 4B).

Apoptosis of alveolar cells was evaluated with TUNEL staining. TUNEL positive cells were hardly found in the Sham group. About 2% of TUNEL positive cells were found in the Perfadex group. Both Perfadex-ARG and RPMI-D(p) solutions significantly reduced cell death, and RPMI-D(p) group was significantly lower than that of Perfadex-ARG group (FIG. 4C, D).

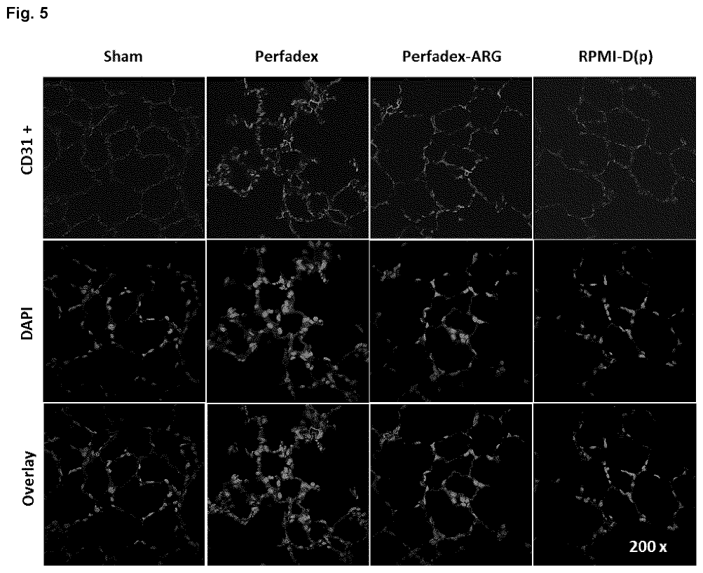

The swelling of alveolar wall indicates increased permeability of microvasculature. CD31 was used as an endothelial cell marker for immunofluorescent staining. Donor lungs preserved with Perfadex™ showed enhanced CD31 staining, which was clearly reduced in Perfadex-ARG group, and especially in the RPMI-D(p) group (FIG. 5).

### New Formulas Prevented Ultrastructural Changes of Alveoli

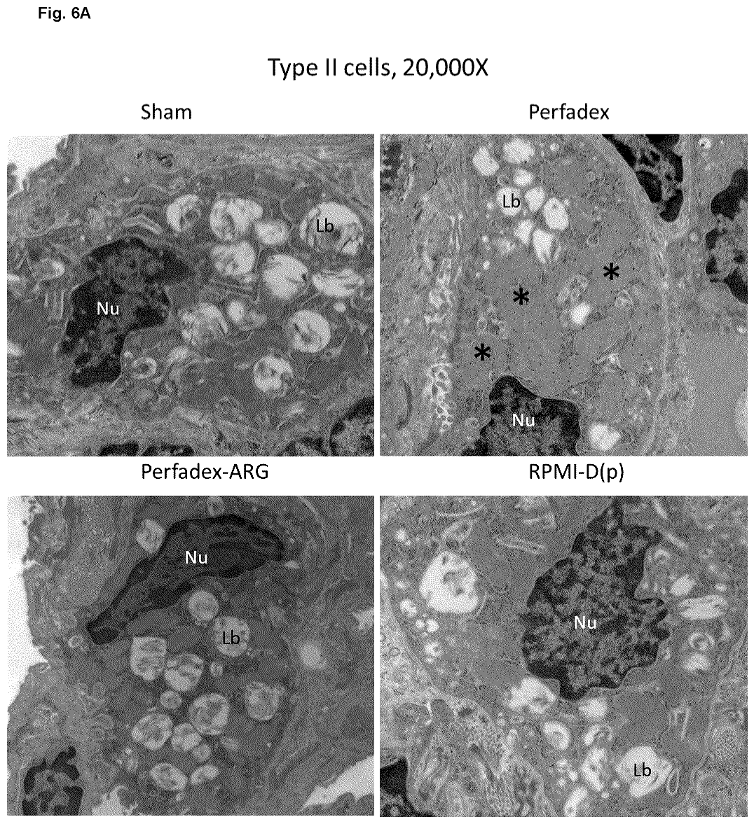

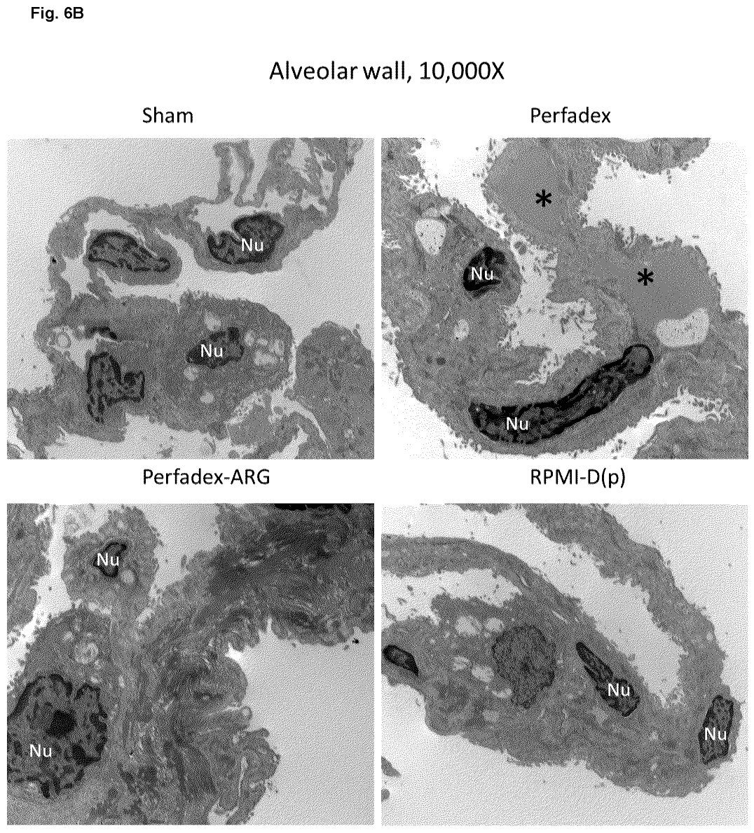

Next, transmission electronic microscopy (TEM) was used to examine the ultra-structure of the alveolar wall, with a first focus on alveolar type II epithelial cells. Lamellar bodies (LB) and nucleus (Nu) were well preserved in all groups. Compared with the Sham group (normal control), the cytoplasm of certain type II cells in the donor lung preserved at 4° C. for 24 h in Perfadex™ solution showed swelling flatten areas (*). In contrast, type II cells in the Perfadex-ARG and RPMI-D(p) groups depicted well-preserved internal structures (FIG. 6A).

Additionally, the alveolar wall in the Sham, Perfadex-ARG and RPMI-D(p) groups exhibit similar morphology, whereas in the Perfadex group, the cytoplasm of many alveolar cells showed evenly distributed flatten areas (*), likely due to cellular edema (FIG. 6B). This kind of cell morphology was not found in the sham group (0/97 nuclei from 20 TEM photos), but the flattened morphology was found in 36% (31/86 nuclei, 23 photos) cells in the Perfadex group, 3% (6/202 nuclei, 202 photos) in the Perfadex-ARG group, and 6% (8/133 nuclei, 27 photos) in the RPMI-D(p) group. The two modified formulas showed significant reduction of edematous cells in comparison with Perfadex group (p<0.001) and had no significant differences from each other.

Results from the present study indicate that adding certain drugs (A1AT, raffinose, glutamine), or nutrients (amino acids, vitamins, and other cytoprotective biochemicals) could protect cells at low temperature over a prolonged time. This discovery may change the future direction of design and development of new organ preservation solutions. It may revolutionize the development of organ preservation solutions. It is expected that in the future, new formulas will be nutrient-rich, instead of simply buffered inorganic salts, and multiple cyto-protective agents will be used in the preservation solutions.

A buffer system in the preservation solution prevents organs from intracellular acidosis. Interestingly, it was found that bicarbonate buffer should be avoided from lung preservation solutions. Even without a buffer system, as seen in normal saline group, it was observed that cell viability is better than when bicarbonate buffer was used. This suggests that under the low temperature, the metabolic rate of lung cells is very low and unable to produce high amounts of CO₂. Several buffer systems have been used in different organ preservation solutions (e.g., phosphate, histidine, HEPES, and THAM) (13). It has been shown that solutions containing zwitterionic sulfonic acid buffers such as HEPES possess superior buffering at low temperature (1). These buffering systems should be further tested with the cell culture model. As mentioned earlier, when donor lungs were preserved at 10° C., better lung function was seen (5). The metabolic rate must be higher at 10° C., choosing the right buffering system will be crucial under that condition.

Comparing the 2 phosphate buffered cell culture media, it was noted that RPMI-1640(p) protected cell viabilities better than that of M199(p). RPMI-1640(p) has higher concentrations of glutamine, which is essential in humans, representing the second most important energy source (next to glucose) for cell proliferation (18). RPMI-1640(p) also has much higher concentrations of glutathione and vitamins (Table 2). Further comparing the details in their components may reveal what components are more important than others.

TABLE 2
Compositions of Culture Media Used in the Study.

| | | | |
|---|---|---|---|
| Constituent | DMEM | M199(p) | RPMI-1640(p) |

Inorganic salts (mM)

| | | | |
|---|---|---|---|
| K⁺ | 5.3 | 5.7 | 5.3 |
| Na⁺ | 156 | 137 | 115 |
| Cl⁻ | 119 | 145 | 109 |
| Ca²⁺ | 1.8 | 1.26 | 0.4 |
| Mg²⁺ | 0.8 | 0.8 | 0.4 |

Buffer (mM)

| | | | |
|---|---|---|---|
| HCO₃_{^{−}} | 44 | | |
| H₂PO₄⁻/HPO₄²⁻ | 0.9/0 | 0.44/0.33 | 0/5.6 |

Amino acids (mg/L)

| | | | |
|---|---|---|---|
| Glycine | 30 | 50 | 10 |
| L-Arginine HCl | 84 | 70 | — |
| L-Cystine 2HCl | 63 | 26 | 65 |
| L-Glutamine | 584 | 100 | 300 |
| L-Histidine HCl•H₂O | 42 | 22 | 15 |
| L-Isoleucine | 105 | 40 | 50 |
| L-Leucine | 105 | 60 | 50 |
| L-Lysine HCl | 146 | 15 | 40 |
| L-Methionine | 30 | 15 | 15 |
| L-Phenylalanine | 66 | 25 | 15 |
| L-Serine | 42 | 25 | 30 |
| L-Threonine | 95 | 30 | 20 |
| L-Tryptophan | 16 | 10 | 5 |
| L-Tyrosine disodium salt•2H₂O | 104 | 58 | 29 |
| L-Valine | 94 | 25 | 20 |
| L-Alanine | | 25 | — |
| L-Aspartic acid | | 30 | 20 |
| L-Cysteine HCl•H₂O | | 0.1 | |
| L-Glutamic Acid | | 75 | 20 |
| L-Hydroxyproline | | 10 | 20 |
| L-Proline | | 40 | 20 |
| L-Arginine | | | 200 |
| L-Asparagine | | | 50 |

Vitamins (mg/L)

| | | | |
|---|---|---|---|
| Choline Chloride | 4 | 0.5 | 3.0 |
| D-Calcium pantothenate | 4 | 0.01 | 0.25 |
| Folic Acid | 4 | 0.01 | 1.0 |
| Niacinamide (nicotinamide) | 4 | 0.025 | 1.0 |
| Pyridoxine HCl | 4 | 0.05 | 1.0 |
| Riboflavin | 0.4 | 0.01 | 0.2 |
| Thiamine HCl | 4 | 0.01 | 1 |
| i-Inositol | 7.2 | 0.05 | 35 |
| Ascorbic Acid | | 0.05 | |
| Biotin | | 0.01 | 0.2 |
| Nicotinic acid | | 0.025 | |
| Para-Aminobenzoic Acid | | 0.05 | 1.0 |
| Vitamin A (acetate) | | 0.14 | |
| Vitamin D2 (Calciferol) | | 0.1 | |
| DL-alpha-Tocopherol•PO₄•Na | | 0.01 | |
| Menadione•NaHSO₃•3H₂O | | 0.019 | |
| Vitamin B₁₂ | | | 0.005 |
| Glucose (mg/L) | 1,000 | 1,000 | 2,000 |
| Glutathione (mg/L) | — | 0.05 | 1 |
| Phenol red, Na (mg/L) | 15 | 10 | 5 |

Others

| | | | |
|---|---|---|---|
| Adenine sulfate | | 10 | |
| 5-Adenylic acid•H₂O | | 0.2 | |
| ATP, 2Na•3H₂O | | 1 | |
| Cholesterol | | 0.2 | |
| 2-deoxy-D-ribose | | 0.5 | |
| Guanine•HCl | | 0.3 | |
| Hypoxanthine, Na | | 0.354 | |
| D-Ribose | | 0.5 | |
| Sodium acetate | | 50 | |
| Thymine | | 0.3 | |
| Tween 80 | | 20 | |
| Uracil | | 0.3 | |
| Xanthine, Na | | 0.34 | |
| Ferric nitrate | 0.1 | | |
| Sulphate | 0.8 | | |
| Pyruvate | 1 | | |
| pH | 7.20 | 7.20 | 7.20 |
| Osmolarity (mOsm/L) | 330 ± 30 | 290 ± 20 | 290 ± 30 |

TABLE 3
Broadest Ranges of Concentrations
of Constituents in Nutrient Media

| | |
|---|---|
| | Concentration |
| Constituent | Range |

Inorganic salts (mM)

| | |
|---|---|
| K⁺ | 5.3-6 |
| Na⁺ | 115-156 |
| Cl⁻ | 109-145 |
| Ca²⁺ | 0-1.8 |
| Mg²⁺ | 0.4-0.8 |

Buffer (mM)

| | |
|---|---|
| H₂PO₄_{^{−}} | 0-0.9 |
| HPO₄²⁻ | 0.33-5.6 |

Amino acids (mg/L)

| | |
|---|---|
| Glycine | 10-50 |
| L-Arginine HCl | 0-84 |
| L-Cystine 2HCl | 26-65 |
| L-Glutamine | 100-584 |
| L-Histidine HCl•H₂O | 15-42 |
| L-Isoleucine | 40-105 |
| L-Leucine | 50-105 |
| L-Lysine HCl | 15-146 |
| L-Methionine | 15-30 |
| L-Phenylalanine | 15-66 |
| L-Serine | 25-42 |
| L-Threonine | 20-95 |
| L-Tryptophan | 5-16 |
| L-Tyrosine disodium salt•2H₂O | 29-104 |
| L-Valine | 20-94 |
| L-Alanine | 0-25 |
| L-Aspartic acid | 20-30 |
| L-Cysteine HCl·H₂O | 0-0.1 |
| L-Glutamic Acid | 20-75 |
| L-Hydroxyproline | 10-20 |
| L-Proline | 20-40 |
| L-Arginine | 0-200 |
| L-Asparagine | 0-50 |

Vitamins (mg/L)

| | |
|---|---|
| Choline Chloride | 0.5-4 |
| D-Calcium pantothenate | 0.01-4 |
| Folic Acid | 0.010-4 |
| Niacinamide (nicotinamide) | 0.025-4 |
| Pyridoxine HCl | 0.05-4 |
| Riboflavin | 0.01-0.4 |
| Thiamine HCl | 0.01-4 |
| i-Inositol | 0.05-35 |
| Ascorbic Acid | 0-0.05 |
| Biotin | 0.01-0.2 |
| Nicotinic acid | 0-0.025 |
| Para-Aminobenzoic Acid | 0.05-1.0 |
| Vitamin A (acetate) | 0-0.14 |
| Vitamin D2 (Calciferol) | 0-0.1 |
| DL-alpha-Tocopherol•PO₄•Na | 0-0.01 |
| Menadione•NaHSO₃•3H₂O | 0-0.019 |
| Vitamin B₁₂ | 0-0.005 |
| Glucose (mg/L) | 1,000-2,000 |
| Glutathione (mg/L) | 0.05-1 |
| Phenol red, Na (mg/L) | 5-15 |

Others

| | |
|---|---|
| Adenine sulfate | 0-10 |
| 5-Adenylic acid•H₂O | 0-0.2 |
| ATP, 2Na•3H₂O | 0-0-1 |
| Cholesterol | 0-0.2 |
| 2-deoxy-D-ribose | 0-0.5 |
| Guanine•HCl | 0-0.3 |
| Hypoxanthine, Na | 0-0.354 |
| D-Ribose | 0-0.5 |
| Sodium acetate | 0-50 |
| Thymine | 0-0.3 |
| Tween 80 | 0-20 |
| Uracil | 0-0.3 |
| Xanthine, Na | 0-0.3 |

TABLE 4
Narrower Ranges of Concentrations
of Constituents in Nutrient Media

| | |
|---|---|
| | Concentration |
| Constituent | Range |

Inorganic salts (mM)

| | |
|---|---|
| K⁺ | 5.3-6 |
| Na⁺ | 115-138 |
| Cl⁻ | 109-145 |
| Ca²⁺ | up to 1.26 |
| Mg²⁺ | 0.4-0.8 |

Buffer (mM)

| | |
|---|---|
| H₂PO₄_{^{−}} | 0-0.8 |
| HPO₄²⁻ | 0.33-5.6 |

Amino acids (mg/L)

| | |
|---|---|
| Glycine | 10-50 |
| L-Arginine HCl | 0-70 |
| L-Cystine 2HCl | 26-65 |
| L-Glutamine | 100-300 |
| L-Histidine HCl•H₂O | 15-22 |
| L-Isoleucine | 40-50 |
| L-Leucine | 50-60 |
| L-Lysine HCl | 15-40 |
| L-Methionine | 15 |
| L-Phenylalanine | 15-25 |
| L-Serine | 25-30 |
| L-Threonine | 20-30 |
| L-Tryptophan | 5-10 |
| L-Tyrosine disodium salt•2H₂O | 29-58 |
| L-Valine | 20-25 |
| L-Alanine | 0-25 |
| L-Aspartic acid | 20-30 |
| L-Cysteine HCl•H₂O | 0-0.1 |
| L-Glutamic Acid | 20-75 |
| L-Hydroxyproline | 10-20 |
| L-Proline | 20-40 |
| L-Arginine | 0-200 |
| L-Asparagine | 0-50 |

Vitamins (mg/L)

| | |
|---|---|
| Choline Chloride | 0.5-3.0 |
| D-Calcium pantothenate | 0.01-0.25 |
| Folic Acid | 0.010-1.0 |
| Niacinamide (nicotinamide) | 0.025-1.0 |
| Pyridoxine HCl | 0.05-1.0 |
| Riboflavin | 0.01-0.2 |
| Thiamine HCl | 0.02-1 |
| i-Inositol | 0.05-35 |
| Ascorbic Acid | 0-0.05 |
| Biotin | 0.01-0.2 |
| Nicotinic acid | 0-0.025 |
| Para-Aminobenzoic Acid | 0.05-1.0 |
| Vitamin A (acetate) | 0-0.14 |
| Vitamin D2 (Calciferol) | 0-0.1 |
| DL-alpha-Tocopherol•PO₄•Na | 0-0.01 |
| Menadione•NaHSO₃•3H₂O | 0-0.019 |
| Vitamin B₁₂ | 0-0.005 |
| Glucose (mg/L) | 1,000-2,000 |
| Glutathione (mg/L) | 0.05-1 |
| Phenol red, Na (mg/L) | 5-10 |

Others

| | |
|---|---|
| Adenine sulfate | up to 10 |
| 5-Adenylic acid•H₂O | up to 0.2 |
| ATP, 2Na•3H₂O | up to 0-1 |
| Cholesterol | up to 0.2 |
| 2-deoxy-D-ribose | up to 0.5 |
| Guanine•HCl | up to 0.3 |
| Hypoxanthine, Na | up to 0.354 |
| D-Ribose | up to 0.5 |
| Sodium acetate | up to 50 |
| Thymine | up to 0.3 |
| Tween 80 | up to 20 |
| Uracil | up to 0.3 |
| Xanthine, Na | up to 0.3 |

The dextran 40 is an oncotic agent, and it may prevent cellular edema formation. Adding dextran 40 improved cytoprotective ability of M199(p). On the other hand, adding dextran 40 to RPMI-1640(p) did not further improve cell viability, which may be due to superior protective effects of RPMI-1640(p) alone on both human lung epithelial and endothelial cells. We choose RPMI-1640(p) plus dextran 40 as a new preservation formula, RPMI1640-D(p), and further tested it in rat lung preservation model. However, it may also be that M199(p) and other cell culture media with modified buffering systems could be used for organ preservation, either alone, or in combination with other agents.

For comparison, A1AT (a protease inhibitor with anti-inflammatory, anti-apoptotic and or anti-necroptotic activities), raffinose (an impermeant), and glutathione (an antioxidant) were added into Perfadex™, as a new formula—Perfadex-ARG. It showed superior protection to the donor lung than Perfadex™ alone. This result not only indicates that this could be another candidate of lung preservation solution, but also suggesting that selecting an appropriate impermeant, maintaining the balance between oxidant and antioxidant, inhibiting protease activity, inflammation and cytoprotective effects may improve donor organ preservation. Adding multiple therapeutic agents may have additive effects on cell viability. The contributions of each of these additives can be further tested with the cell culture model.

The in vivo tests described here showed that after 24 h of cold static storage, the lung morphology in all groups is normal. Only after careful morphologic analyses alveolar wall swelling is noted in the Perfadex group, which was significantly reduced in other two groups, especially in RPMI-D(p) group. The increased interstitial edema is associated with increased apoptosis and activation of endothelial cells. It should be pointed out that even though the apoptosis ratio was statistically increased in the Perfadex group, it was only about 2%, which is very low compared with those seen in other experimental conditions related to donor lung injury (12, 14, 19, 21). Ultrastructural studies with TEM also showed that in the Perfadex group, the images in the cytoplasma are lack of details, indicating edematous changes of the cell. It should be pointed out that our control is not simply using Perfadex; PGE1 was added to improve the cytoprotective effects based on our previous studies (6). The protective effects of Perfadex-ARG and RPMI-D(p) solutions are on top of this combination.

### REFERENCES

1. Baicu S C, and Taylor M J. Acid-base buffering in organ preservation solutions as a function of temperature: new parameters for comparing buffer capacity and efficiency. Cryobiology 45: 33-48, 2002.
2. Cardella J A, Keshavjee S, Mourgeon E, Cassivi S D, Fischer S, Isowa N, Slutsky A, and Liu M. A novel cell culture model for studying ischemia-reperfusion injury in lung transplantation. J Appl Physiol (1985) 89: 1553-1560, 2000.
3. Casiraghi M, Tatreau J R, Abano J B, Blackwell J W, Watson L, Burridge K, Randell S H, and Egan™. In vitro modeling of nonhypoxic cold ischemia-reperfusion simulating lung transplantation. J Thorac Cardiovasc Surg 138: 760-767, 2009.
4. Collins G M, Bravo-Shugarman M, and Terasaki P I. Kidney preservation for transportation. Initial perfusion and 30 hours' ice storage. Lancet 2: 1219-1222, 1969.
5. Date H, Lima O, Matsumura A, Tsuji H, d′Avignon D A, and Cooper J D. In a canine model, lung preservation at 10 degrees C. is superior to that at 4 degrees C. A comparison of two preservation temperatures on lung function and on adenosine triphosphate level measured by phosphorus 31-nuclear magnetic resonance. J Thorac Cardiovasc Surg 103: 773-780, 1992.
6. de Perrot M, Fischer S, Liu M, Jin R, Bai X H, Waddell T K, and Keshavjee S. Prostaglandin E1 protects lung transplants from ischemia-reperfusion injury: a shift from pro- to anti-inflammatory cytokines. Transplantation 72: 1505-1512, 2001.
7. Fischer S, Hopkinson D, Liu M, and Keshavjee S. Raffinose improves the function of rat pulmonary grafts stored for twenty-four hours in low-potassium dextran solution. J Thorac Cardiovasc Surg 119: 488-492, 2000.
8. Fischer S, Hopkinson D, Liu M, MacLean A A, Edwards V, Cutz E, and Keshavjee S. Raffinose improves 24-hour lung preservation in low potassium dextran glucose solution: a histologic and ultrastructural analysis. Ann Thorac Surg 71: 1140-1145, 2001.
9. Gao W, Zhao J, Kim H, Xu S, Chen M, Bai X, Toba H, Cho H R, Zhang H, Keshavjeel S, and Liu M. alpha1-Antitrypsin inhibits ischemia reperfusion-induced lung injury by reducing inflammatory response and cell death. J Heart Lung Transplant 33: 309-315, 2014.
10. Gao X, Liu W, and Liu M. Ex Vivo Lung Perfusion: Scientific Research and Clinical Application. Pract J Organ Transplant 5: 177-187, 2017.
11. Huh D, Matthews B D, Mammoto A, Montoya-Zavala M, Hsin H Y, Ingber D E. Reconstituting organ-level lung functions on a chip. Science. 328: 1662-1668, 2010.
12. Iskender I, Sakamoto J, Nakajima D, Lin H, Chen M, Kim H, Guan Z, Del Sorbo L, Hwang D, Waddell T K, Cypel M, Keshavjee S, and Liu M. Human alpha1-antitrypsin improves early post-transplant lung function: Pre-clinical studies in a pig lung transplant model. J Heart Lung Transplant 35: 913-921, 2016.
13. Jing L, Yao L, Zhao M, Peng L P, and Liu M. Organ preservation: from the past to the future. Acta Pharmacol Sin 39: 845-857, 2018.
14. Kanou T, Ohsumi A, Kim H, Chen M, Bai X, Guan Z, Hwang D, Cypel M, Keshavjee S, and Liu M. Inhibition of regulated necrosis attenuates receptor-interacting protein kinase 1-mediated ischemia-reperfusion injury after lung transplantation. J Heart Lung Transplant 37: 1261-1270, 2018.
15. Keshavjee S H, Yamazaki F, Cardoso P F, McRitchie D I, Patterson G A, and Cooper J D. A method for safe twelve-hour pulmonary preservation. J Thorac Cardiovasc Surg 98: 529-534, 1989.
16. Kim H, Zamel R, Bai X H, Lu C, Keshavjee S, Keshavjee S, and Liu M. Ischemia-reperfusion induces death receptor-independent necroptosis via calpain-STAT3 activation in a lung transplant setting. Am J Physiol Lung Cell Mol Physiol 315: L595-L608, 2018.
17. Kim H, Zhao J, Zhang Q, Wang Y, Lee D, Bai X, Turrell L, Chen M, Gao W, Keshavjee S, and Liu M. deltaV1-1 Reduces Pulmonary Ischemia Reperfusion-Induced Lung Injury by Inhibiting Necrosis and Mitochondrial Localization of PKCdelta and p53. Am J Transplant 16: 83-98, 2016.
18. Lai C C, Liu W L, and Chen C M. Glutamine attenuates acute lung injury caused by acid aspiration. Nutrients 6: 3101-3116, 2014.
19. Lee D, Zhao J B, Yang H, Xu S Y, Kim H, Pacheco S, Keshavjee S, and Liu M Y. Effective delivery of a rationally designed intracellular peptide drug with gold nanoparticle-peptide hybrids. Nanoscale 7: 12356-12360, 2015.
20. Li Z, Overend C, Maitz P, and Kennedy P. Quality evaluation of meshed split-thickness skin grafts stored at 4 degrees C. in isotonic solutions and nutrient media by cell cultures. Burns 38: 899-907, 2012.
21. Lin H, Chen M, Tian F, Tikkanen J, Ding L, Andrew Cheung H Y, Nakajima D, Wang Z, Mariscal A, Hwang D, Cypel M, Keshavjee S, and Liu M. alpha1-Anti-trypsin improves function of porcine donor lungs during ex-vivo lung perfusion. J Heart Lung Transplant 37: 656-666, 2018.
22. Mariscal A, Nykanen A, Tikkanen J, Ali A, Soltanieh S, Duong A, Galasso M, Juvet S, Martinu T, Cypel M, Liu M, and Keshavjee S. Alpha 1 Antitrypsin Treatment during Human Ex Vivo Lung Perfusion Improves Lung Function by Protecting Lung Endothelium [abstract]. J Heart Lung Transplant 37: S71-S72, 2020.
23. Omasa M, Hasegawa S, Bando T, Hanaoka N, Yoshimura T, Nakamura T, and Wada H. Application of ET-Kyoto solution in clinical lung transplantation. Ann Thorac Surg 77: 338-339, 2004.
24. Toronto Lung Transplant Group. Unilateral lung transplantation for pulmonary fibrosis. N Engl J Med 314: 1140-1145, 1986.
25. Wahlberg J A, Southard J H, and Belzer F O. Development of a cold storage solution for pancreas preservation. Cryobiology 23: 477-482, 1986.
26. Ali A, Wang A, Ribeiro R V P, Beroncal E L, Baciu C, Galasso M, Gomes B, Mariscal A, Hough O, Brambate E, Abdelnour-Berchtold E, Michaelsen V, Zhang Y, Gazzalle A, Fan E, Brochard L, Yeung J, Waddell T, Liu M, Andreazza A C, Keshavjee S, Cypel M. Static lung storage at 10° C. maintains mitochondrial health and preserves donor organ function. Sci Transl Med 2021 Sep. 15; 13(611): eabf7601. doi: 10.1126/scitranslmed.abf7601.

1. A lung preservation composition comprising a non-carbonic buffered nutrient media, the non-carbonic buffered nutrient media comprising at least one amino acid and at least one vitamin; and a dextran and optionally prostaglandin E1 (PGE1).

2. The lung preservation composition of claim 1, wherein the composition further comprises at least one of alpha 1 antitrypsin (A1AT), necrostatin-1, one or more impermeant, and/or one or more antioxidant.

3. The lung preservation composition of claim 1 or 2, wherein the non-carbonic buffered nutrient media lacks serum.

4. The lung preservation composition of any one of claims 1 to 3, wherein the non-carbonic buffered nutrient media is a phosphate, THAM, histidine, and/or zwitterionic sulfonic acid, optionally HEPES, buffered nutrient media or comprises a phosphate, THAM, histidine, and/or zwitterionic sulfonic acid, optionally HEPES, buffer.

5. The lung preservation composition of any one of claims 1 to 4, wherein the dextran is Dextran 40.

6. The lung preservation composition of any one of claims 1 to 5, wherein the impermeant is raffinose.

7. The lung preservation composition of any one of claims 1 to 6, wherein the antioxidant is glutathione.

8. The lung preservation composition of any one of claims 1 to 7, the non-carbonic buffered nutrient media is or comprises a cell culture media lacking a bicarbonate buffer and serum.

9. The lung preservation composition of any one of claims 5 to 8, wherein the concentration of Dextran 40 is about 50 mg/mL.

10. The lung preservation composition of any one of claims 1 to 9, wherein the concentration of PGE1 is from about 100 mg/L about 10,000 mg/mL, preferably 500 mg/L.

11. The lung preservation composition of any one of claims 7 to 10, wherein the concentration of glutathione is about 0.05 mg/L to about 2 mg/L, preferably about 1 mg/L.

12. The lung preservation composition of any one of claims 6 to 11, wherein the concentration of raffinose is about 30 mmol/L to about 50 mmol/L, preferably about 35 mmol/L.

13. The lung preservation composition of any one of claims 2 to 12, wherein the concentration of A1AT is about 1 mg/mL to about 5 mg/mL, preferably 1 mg/mL.

14. The lung preservation composition of any one of claims 1 to 13, wherein the non-carbonic buffered nutrient media is a phosphate buffered nutrient media or comprises a phosphate buffer.

15. The lung preservation composition of any one of claims 1 to 14, wherein the composition further comprises Na⁺, K⁺, Cl⁻, Mg²⁺, Ca²⁺, optionally in the concentrations provided in Table 2.

16. The lung preservation composition of any one of claims 1 to 15, wherein the at least one amino acid selected from L-Cystine, L-Glutamine, L-Isoleucine, L-Leucine, L-Lysine, L-Methionine, L-Phenylalanine, L-Serine, L-Threonine, L-Tyrosine, L-Valine, L-Hydroxyproline, L-Proline and/or L-Arginine.

17. The lung preservation composition of any one of claims 1 to 16, wherein the at least one amino acid is at least three essential amino acids.

18. The lung preservation composition of any one of claims 1 to 17, wherein the at least one amino acid is present in a concentration as provided in Table 3.

19. The lung preservation composition of any one of claims 1 to 18, wherein the at least one amino acid is present in a concentration provided in the RPMI-1640(p) composition as provided in Table 2.

20. The lung preservation composition of any one of claims 1 to 19, wherein the at least one vitamin is selected from or comprises choline, Calcium pantothenate, folic acid, niacinamide, pyridoxine, riboflavin, thiamine, inositol, biotin, para-aminobenzoic acid, and/or vitamin B12.

21. The lung preservation composition of any one of claims 1 to 20, wherein the at least one vitamin is present in a concentration as provided in Table 3.

22. The lung preservation composition of any one of claims 1 to 21, wherein the at least one vitamin is present in a concentration provided in the RPMI-1640(p) composition as provided in Table 2.

23. The lung preservation composition of any one of claims 1 to 22, wherein the composition further comprises Adenine sulfate, 5-Adenylic acid H₂O, ATP, 2Na·3H₂O, Cholesterol, 2-deoxy-D-ribose, Guanine·HCl, Hypoxanthine, Na, D-Ribose, Sodium acetate, Thymine, Tween 80, Uracil, Xanthine, Na, optionally in the concentrations provided in Table 2.

24. The lung preservation composition of claims 1 to 23, wherein the at least one amino acid is L-Glutamine.

25. The lung preservation composition of claim 24, wherein the concentration of the L-Glutamine is 300 mg/L.

26. The lung preservation composition of any one of claims 1 to 13, wherein the non-carbonic buffered nutrient media is a phosphate and THAM buffered nutrient media comprising Na⁺, K⁺, Cl⁻, Mg²⁺, glucose, dextran 40, and sulphate.

27. The lung preservation composition of claim 26, wherein the Na⁺ is present in a concentration of 138 mM, the K⁺ is present in a concentration of 6 mM, the Cl⁻ is present in a concentration of 142 mM, the Mg²⁺ is present in a concentration of 0.8 mM, the glucose is present in a concentration of 5.5 mM, the dextran 40 is present in a concentration of 50 g/L, the phosphate is present in a concentration of 0.8 mM, and the THAM is present in a concentration of 1 mM.

28. The lung preservation composition of any one of claims 1 to 27, wherein the non-carbonic buffered nutrient media has a pH of about 7.2 to about 7.4.

29. The lung preservation composition of any one of claims 1 to 28, wherein the non-carbonic buffered nutrient media has an osmolarity of about 260 mOsm/L to about 320 mOsm/L.

30. The lung preservation composition of claim 29, wherein the non-carbonic buffered nutrient media has an osmolarity of about 290 mOsm/L. 300 mOsm/L, 310 mOsm/L or 320 mOsm/L.

31. The lung preservation composition any one of claims 1 to 30, wherein the lung preservation composition has an osmolarity of more than 300 mOsm/L.

32. The lung preservation composition of any one of claims 1 to 31, wherein the organ preservation composition comprises a pH between about 7.2 and about 7.6 or pH between about 7.35 and about 7.45.

33. The lung preservation composition of any one of claims 1 to 32, wherein the non-carbonic buffered nutrient media is sterile.

34. A method of cooling and/or preserving a lung prior to transplant, the method comprising: obtaining a lung from a donor subject and flushing the lung and/or storing the lung with the lung preservation composition of any one of claims 1 to 33.

35. The method of claim 34 wherein the storing comprising a step of obtaining a volume of the lung preservation composition from a sterile container in which the composition has been stored and adding the obtained volume to the lung or adding the lung to the obtained volume.

36. The method of claim 34 or 35, wherein the subject is a human.

37. The method of any one of claims 34 to 36, wherein the lung is flushed with the lung preservation composition and then stored at a low temperature for up to about 24 hours.

38. The method of claim 37, wherein the lung is stored for about 6 hours.

39. The method of claim 37, wherein the lung is stored for about 12 hours.

40. The method of claim 37, wherein the lung is stored for about 24 hours.

41. The method of any one of claims 37 to 40, wherein the low temperature is about 10 degrees.

42. The method of any one of claims 37 to 40, wherein the low temperature is about 4 degrees Celsius.

43. The method of any one of claims 1 to 42, wherein the lung preservation composition is below 37 degrees Celsius.

44. The method of claim 43, wherein the lung preservation composition is below about 15 degrees Celsius.
